(19) United States
(12) Patent Application Publication
(10) Pub. No.: US 2026/0107033 A1
(43) Pub. Date: Apr. 16, 2026

(54) DYNAMIC PAGE UPDATING SYSTEM

(71) Applicant: Netflix, Inc., Los Gatos, CA (US)

(72) Inventors: Donald Raymond DeBoer, III, San Francisco, CA (US); Sreekanth Ramakrishnan, San Francisco, CA (US); Mehmet Mustafa Yilmaz, San Francisco, CA (US); David Gold Shin, Cerritos, CA (US); Ragavika Tarigopula, Los Gatos, CA (US); Michael Albert Galassi, San Jose, CA (US); Itay Teller, Sunnyvale, CA (US); Paran Jain, Newcastle, WA (US); Michael Wu, Erie, CO (US); Arun Lakshminarayanan, San Jose, CA (US); Shahab Mehmandoust, Los Gatos, CA (US)

(21) Appl. No.: 18/911,906

(22) Filed: Oct. 10, 2024

(51) Int. Cl. H04N 21/431; H04N 21/442; H04N 21/466; H04N 21/482

(52) U.S. Cl. CPC H04N 21/431; H04N 21/44222; H04N 21/4662; H04N 21/482

(57) ABSTRACT

A computer-implemented method includes precomputing various sections of a user interface (UI) that is to be displayed on a client device. The method also includes instantiating event listeners associated with corresponding precomputed sections of the UI that are subject to change based on the occurrence of an associated event. The event listeners are configured to provide, for various changeable sections of the UI, an indication of whether the event associated with the event listener has occurred. Upon determining that the event associated with the event listener has occurred, the method includes adaptively generating an updated version of the corresponding section of the UI that is associated with the identified event listener and dynamically updating the user interface to include the adaptively generated, updated version of the corresponding user interface section. Various other methods, systems, and computer-readable media are also disclosed.

### BACKGROUND

Media content provisioning systems provide online access to movies, television shows, video games, and other media content. These provisioning systems typically present media content in a user interface that allows users to select specific media items for consumption. As users select and watch particular media items over time, the provisioning system tracks the users'selections and stores an indication of their interests. Then, prior to subsequent user logins, the provisioning system generates the user interface in advance based on the users'prior selections and preferences. This pre-generation allows the provisioning system to provide the user interface more efficiently. However, if some parts of the user interface need to be reformulated due to the introduction of new content or due to other circumstances, the provisioning system may not be equipped to handle the changes in an efficient manner.

### SUMMARY

As will be described in greater detail below, the present disclosure generally describes systems and methods for dynamically updating precomputed user interface sections of an interactive user interface.

In one example, a computer-implemented method is provided for dynamically updating precomputed user interface sections of an interactive user interface. The method includes precomputing various sections of a user interface (UI) that is to be displayed on a client device. The method next includes instantiating event listeners associated with corresponding precomputed sections of the UI that are subject to change based on the occurrence of an associated event. The event listeners are configured to provide, for various changeable sections of the UI, an indication of whether the event associated with the event listener has occurred. Then, upon determining that the event associated with the event listener has occurred, the method includes adaptively generating an updated version of the corresponding section of the UI that is associated with the identified event listener. The method also includes dynamically updating the user interface to include the adaptively generated, updated version of the corresponding user interface section.

In some embodiments, each of the event listeners is specifically assigned to listen for events from a different precomputed section of the UI. In some cases, at least two event listeners include different types of event listeners. In some examples, the method further includes receiving an input from the client device interacting with the user interface, determining that the input received from the client device includes an event associated with a specified UI section, and dynamically updating the specified UI section to include a newly updated version of the specified UI section.

In some cases, the input received from the client device includes input selecting at least one media item from the user interface. In some embodiments, the UI is dynamically updated as further events are triggered for different precomputed sections of the UI.

In some cases, the event associated with the event listener includes at least one of: an explicit signal from the client device, an implicit signal from the client device, or a system-wide event. In some examples, the method further includes determining that a specified user interface section is being recomputed based on the occurrence of the event associated with the event listener and signaling that further updates to the specified user interface section are to be preempted until completion of the recompute. In some cases, a plurality of user interface sections are precomputed based on likely inputs received at the client device.

In some embodiments, the precomputed user interface sections are stored in and served from a page buffer. In some cases, the precomputed user interface sections are served from the page buffer along with at least a portion of aggregated, served page state. In some examples, the precomputed user interface sections are additionally served with page information that was computed offline, prior to initiation of a current client session.

In some cases, the method includes training one or more machine learning (ML) models to determine which user interface sections are to be presented on the client device. In such cases, the ML models further determine which entities to place in each user interface section. In some embodiments, the ML models further determine in which order to place the entities within the user interface based on contextual information associated with the client device or based on user preferences.

A corresponding system includes at least one physical processor and physical memory including computer-executable instructions that, when executed by the physical processor, cause the physical processor to: precompute one or more sections of a user interface (UI) that is to be displayed on a client device, instantiate one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred, upon determining that the event associated with the event listener has occurred, adaptively generate an updated version of the corresponding section of the UI that is associated with the identified event listener, and dynamically update the user interface to include the adaptively generated, updated version of the corresponding user interface section.

In some examples, a corresponding non-transitory computer-readable medium is provided that includes one or more computer-executable instructions that, when executed by at least one processor of a computing device, cause the computing device to: precompute one or more sections of a user interface (UI) that is to be displayed on a client device, instantiate one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred, upon determining that the event associated with the event listener has occurred, adaptively generate an updated version of the corresponding section of the UI that is associated with the identified event listener, and dynamically update the user interface to include the adaptively generated, updated version of the corresponding user interface section.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example computer architecture in which the embodiments described herein may operate.

FIG. 2 illustrates a flow diagram of an exemplary method for dynamically updating precomputed user interface sections of an interactive user interface.

FIG. 3 illustrates an alternative example computer architecture in which the embodiments described herein may operate.

FIG. 4 illustrates a flow diagram in which precomputed user interface sections of an interactive user interface are dynamically updated.

FIGS. 5A-5D illustrate alternative flow diagrams in which precomputed user interface sections of an interactive user interface are dynamically updated.

FIG. 6 illustrates an embodiment of a chart in which modified page responses are used to replace existing UI page sections.

FIG. 7 is a block diagram of an exemplary content distribution ecosystem.

FIG. 8 is a block diagram of an exemplary distribution infrastructure within the content distribution ecosystem shown in FIG. 7.

FIG. 9 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to dynamically updating precomputed user interface (UI) sections of an interactive user interface. In some cases, ML models are trained and implemented to determine which media items to present and how those media items are to be presented within the UI.

As noted above, media provisioning systems provide access to movies, television shows, video games, and other media content. In some cases, users may subscribe to a media streaming service to gain access to this media content. After a user logs in to the provisioning system, the service will generate and present a user interface that includes an arrangement of media items that can be selected by the user (e.g., arranged in rows and/or columns). From there, the user can browse to various media items and select those media items that the user is interested in viewing.

As users select and watch particular media items or play particular video games throughout the life of their subscription, the media streaming service may learn about the users'interests and tastes in media items. The media streaming service may then proactively generate some parts of the user interface in advance based on the users'prior selections and preferences. This pre-generation process may allow the media streaming service to provide the user interface more promptly and efficiently upon login.

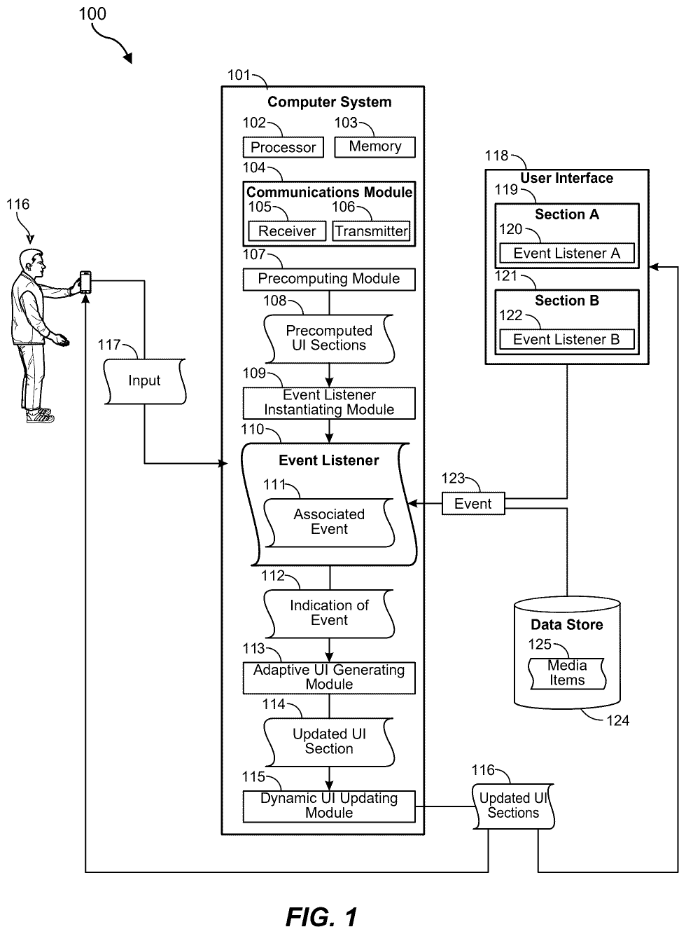

In some cases, as will be explained further below, the systems herein may continue to precompute different UI sections even after the initial UI page is provisioned. These UI sections may correspond to trending items that are highly viewed on the streaming service, or recently watched items that the user has been previously viewing (e.g., television shows or movies that are halfway completed), recommended items that the streaming service thinks the user will be interested in, or other UI sections of media content. At least in some embodiments, the systems herein may use precomputed results even if the precomputed results become available after a new UI page request starts. The systems herein may initiate various event listeners that are notified when dynamically generated precompute results become available, and then abandon the previously started, live computing process, using the precomputed results instead. These processes will be described in greater detail below with reference to FIGS. 1-9.

FIG. 1, for example, illustrates a computing environment 100 in which precomputed user interface sections of an interactive user interface are dynamically updated. FIG. 1 includes various electronic components and elements including a computer system 101 that is used, alone or in combination with other computer systems, to perform associated tasks. The computer system 101 may be substantially any type of computer system including a local computer system or a distributed (e.g., cloud) computer system. The computer system 101 includes at least one processor 102 and at least some system memory 103. The computer system 101 includes program modules for performing a variety of different functions. The program modules may be hardware-based, software-based, or may include a combination of hardware and software. Each program module uses computing hardware and/or software to perform specified functions, including those described herein below.

In some cases, the communications module 104 is configured to communicate with other computer systems. The communications module 104 includes substantially any wired or wireless communication means that can receive and/or transmit data to or from other computer systems. These communication means include, for example, hardware radios such as a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 is configured to interact with databases, mobile computing devices (such as mobile phones or tablets), embedded computing systems, or other types of computing systems.

The computer system 101 further includes precomputing module 107. The precomputing module 107 may be configured to precompute various sections of a user interface (e.g., UI 118). User interface 118 is designed to be displayed on one or more different electronic devices of client 116 (e.g., a smartphone, a television, a laptop, a tablet, a wearable device, a gaming station, etc.). The UI 118 may include different UI sections (e.g., 119, 121, and others). Each of these UI sections may have its own logic, its own rules, and its own content. For example, a UI section entitled “Trending Now” may include different movies or games than a section entitled “Recommended for You” that shows items tailored specifically for that user. Each UI section may draw on different user preferences, different historical selections, different geographical data, etc. The precomputing module 107 may be configured to precompute one or more of these UI sections 108. The UI sections may be precomputed before the user 116 logs in or may be precomputed after the user logs in, but before that specific UI section is accessed or presented to the user.

The event listener instantiating module 109 of computer system 101 may be implemented to instantiate one or more event listeners 110 and associate those event listeners with different UI sections (e.g., section A (119) or section B (121). Thus, the event listener instantiating module 109 may associate event listener A (120) with UI section A (119) and may associate event listener B (122) with UI section B (121). Other event listeners may be associated with other UI sections. Each event listener may be configured to listen for specific events 111 that are relevant for that corresponding UI section. Events may include a user making a selection (e.g., via input 117), a new media item being introduced into the catalog, a media item being removed from the media catalog, a media item moving up or down in overall popularity rankings, receiving a selection from another user in the same region or from a user that has similar preferences, or other events. If such an event 111 occurs, the event listener instantiating module 109 may provide an indication of the occurrence of that event 112 to the adaptive UI generating module 113.

The adaptive UI generating module 113 of computer system 101 may be configured to generate real time or “in-flight” updated UI sections 114. The updated UI sections 114 may be precomputed before being presented on the user interface 118. In some cases, the computer system may already be in the process of generating a new UI page or a new UI section, and the adaptive UI generating module 113 will finish precomputing the updated UI section 114. In such cases, the dynamic UI updating module 115 may discontinue any in-flight processing that is currently underway to generate the UI page or section and may, instead, update the UI 118 using the adaptively generated UI section 114. This updated UI section 114, along with potentially other updated UI sections 126, may be sent to a client device for dynamic updating within the UI 118 and for presentation on the client's electronic device. The updated UI sections 126 may also be sent to a data store 124 for storage along with various media items 125, including videos, games, photos, or other items. These concepts will be described in greater detail with respect to method 200 of FIG. 2 and FIGS. 1-9 below.

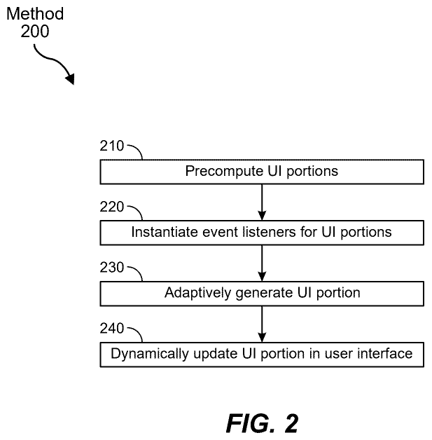

FIG. 2 is a flow diagram of an exemplary computer-implemented method 200 for dynamically updating precomputed user interface sections of an interactive user interface. The steps shown in FIG. 2 may be performed by any suitable computer-executable code and/or computing system, including the systems illustrated in FIG. 1. In one example, each of the steps shown in FIG. 2 may represent an algorithm whose structure includes and/or is represented by multiple sub-steps, examples of which will be provided in greater detail below.

Method 200 includes, at 210, a step for precomputing one or more sections of a user interface (UI) that is to be displayed on a client device. At step 220, method 200 includes instantiating event listeners associated with corresponding precomputed sections of the UI that are subject to change based on the occurrence of an associated event, where the event listeners are configured to provide, for various changeable sections of the UI, an indication of whether the event associated with the event listener has occurred. Upon determining that the event associated with the event listener has occurred, the method 200, at step 230, includes adaptively generating an updated version of the corresponding section of the UI that is associated with the identified event listener. At step 240, the method includes dynamically updating the user interface to include the adaptively generated, updated version of the corresponding user interface section.

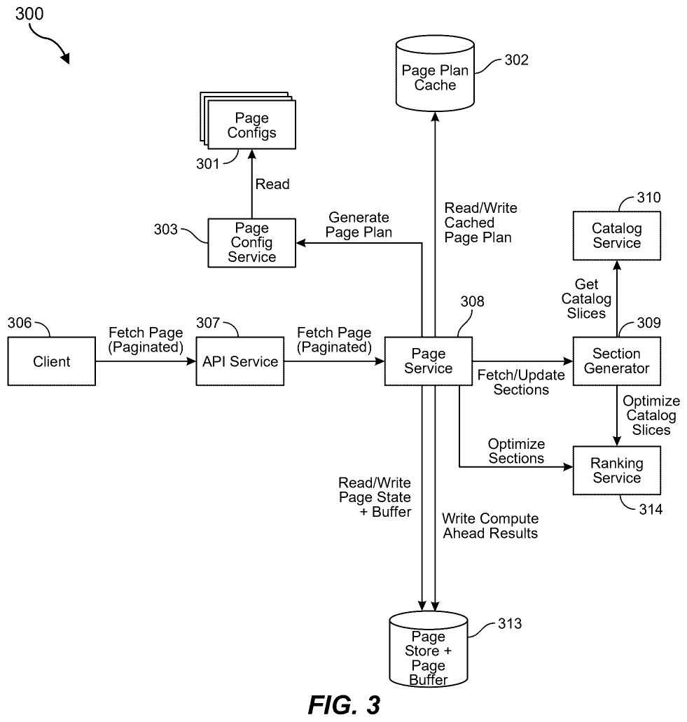

FIG. 3 illustrates an embodiment 300 in which precomputed user interface sections of an interactive user interface may be dynamically updated. Some implementations in the past have used a fixed page structure, which involved precomputing UI pages and imposing certain restrictions on dynamic page modifications that resulted from user interactions. In such cases, the only changes made to the UI page after initial creation involved minor content refreshment. The embodiments described herein, however, provide flexibility in modifying the UI page structure after creation, provide the ability to make substantially any UI section volatile or changeable, shift the responsibility of deciding when to update the UI page from the client to the server, eliminate client-side logic that necessitates knowledge of the identity of different UI section requirements, and empower the server to dictate the course of actions in response to diverse user interactions.

In embodiment 300 of FIG. 3, the page service 308 may be responsible for constructing, serving, and managing the state of UI pages. Each UI page may be constructed according to a UI page plan (as stored in page plan cache 302) via incremental, adaptive computation or via offline precomputation. In some cases, page service 308 may serve the UI page incrementally via a paginated application programming interface (API). The page service 308 may be configured to maintain the current page state (i.e., maintain an indication of which portions of the UI page have already been served to the client 306 via the API service 307). The page service 308 may also be configured to maintain a page buffer, which includes UI sections that are ready to be served and/or added to the page state in the page store 313.

The page config service 303 may be configured to generate page plans, which specify the structure, UI section candidate sets, UI section ranking strategies, etc. for each UI page or UI section. At least in some cases, page plans specifying UI page structure and content may be authored via configuration (e.g., using stored page configurations 301). The page store 313 may be a data store (e.g., a cloud database) that is configured to store the current page state and further store a compute-ahead page buffer for each active UI page. The page state captures what has been served to the client up to a specified point in time and may be used as the basis for further incremental page computation (and for re-serving previously served UI sections). The page buffer may include finalized and ranked UI sections that are ready to be added to the page state. The page buffer may be filled by a just-in-time compute-ahead mechanism operated by the page service 308. The page buffer may reduce subsequent request latency by preemptively computing and caching enough UI page sections to fulfill the next user request without online computation.

The section generator 309 of FIG. 3 may be designed to generate specific UI page sections and may further select which type of UI section will be used and how the UI section will be treated. The section generator 309 may be configured to assign at least some of the responsibility of selecting, filtering, and ranking media items (also referred to herein as “entities” or titles, as ranked by the ranking service 314) to the catalog service 310. In some embodiments, these responsibilities may be given to the section generator 309 and a related data store. The section generator service may be fully or partially page-or session-agnostic and may further be stateless. In such cases, these responsibilities may be assumed by the page service 308.

At least some of the embodiments described herein may include computation strategies for efficiently and flexibly computing UI pages and/or UI page sections. Whereas prior systems may have implemented offline precomputation and all-at-once serving of largely static UI pages, the systems herein provide the ability to apply UI page construction models and/or logic in a much more incremental and responsive manner. These systems may be designed to balance the cost, latency, and freshness of page generation and can be readily tuned according to updated media streaming requirements.

One of the computation strategies that may be implemented herein is online computing. These embodiments may provide incremental (e.g., one or more UI sections at a time), online (i.e., within-request) computation that is driven by client pagination. This may allow other UI section logic to provide more responsive UI experiences. One online computing strategy is asynchronous compute-ahead. Because online computation may increase request latency over serving precomputed pages, the page service 308 may include a compute-ahead mechanism that asynchronously computes the next page or next UI section (e.g., next N page sections, where size is configurable) after each request, in anticipation of a subsequent request. The results of this compute-ahead operation may be stored to the page buffer in page store 313. At the start of each page request, this page buffer may be loaded along with the aggregate served page state (also stored in page store 313). At least in some cases, if possible, the request may be served purely from the existing page state and buffer, without incurring the latency of online computation.

Additionally or alternatively, offline precomputing may be used to dynamically update precomputed user interface sections of an interactive user interface. While the asynchronous compute-ahead mechanism may reduce average latency for subsequent paginated requests, asynchronous compute-ahead may not be designed to help compute the initial page request (asynchronous compute-ahead may be triggered after each request is handled, in anticipation of the next request). The embodiments herein may also implement an offline compute strategy capable of computing and caching the first N page sections (up to a full UI page) for retrieval during a subsequent session. These embodiments may provide the added flexibility to compute partial results and respond to a variety of trigger events.

Still further, adaptive computing may be implemented to dynamically update precomputed UI sections of an interactive user interface. In addition to supporting incremental UI page computation and incremental UI section serving, the systems herein provide support for dynamic adaptation of the page (aka “Adaptive Recommendations”). Adaptive recommendations may be designed to recompute portions of the UI page that have already been computed. In some cases, adaptive recommendations are designed to recompute portions of the UI page that have already been served in response to implicit and explicit user signals and systemic events. For example, if a new title comes online or if a live, televised event begins, that new title or live event may act as an event that signals the precomputation of a UI section that was previously computed and/or served.

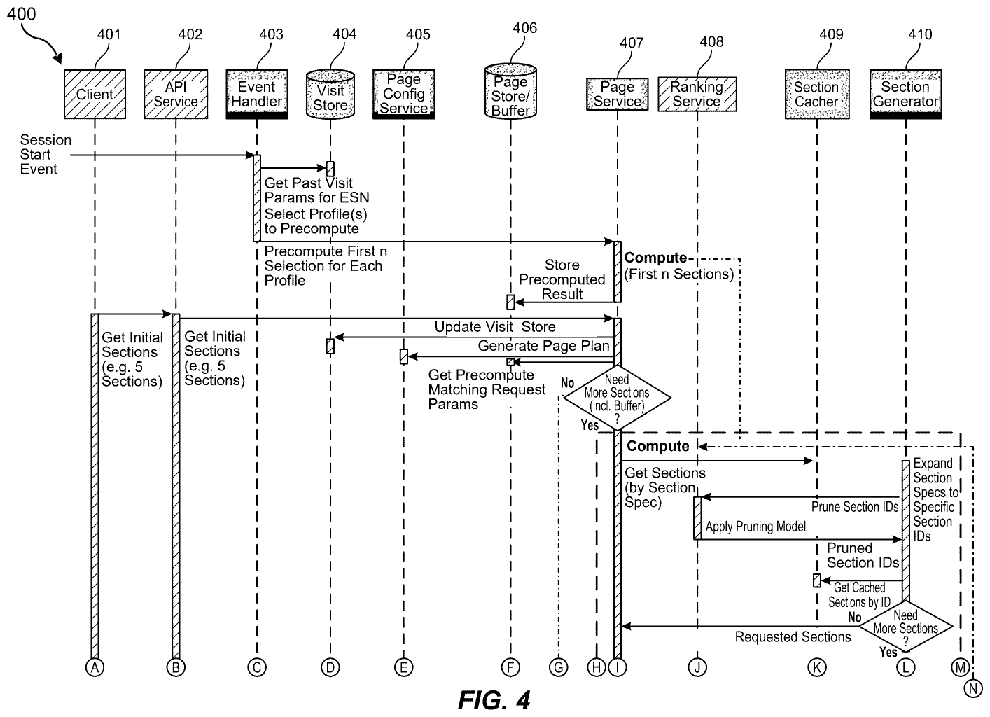

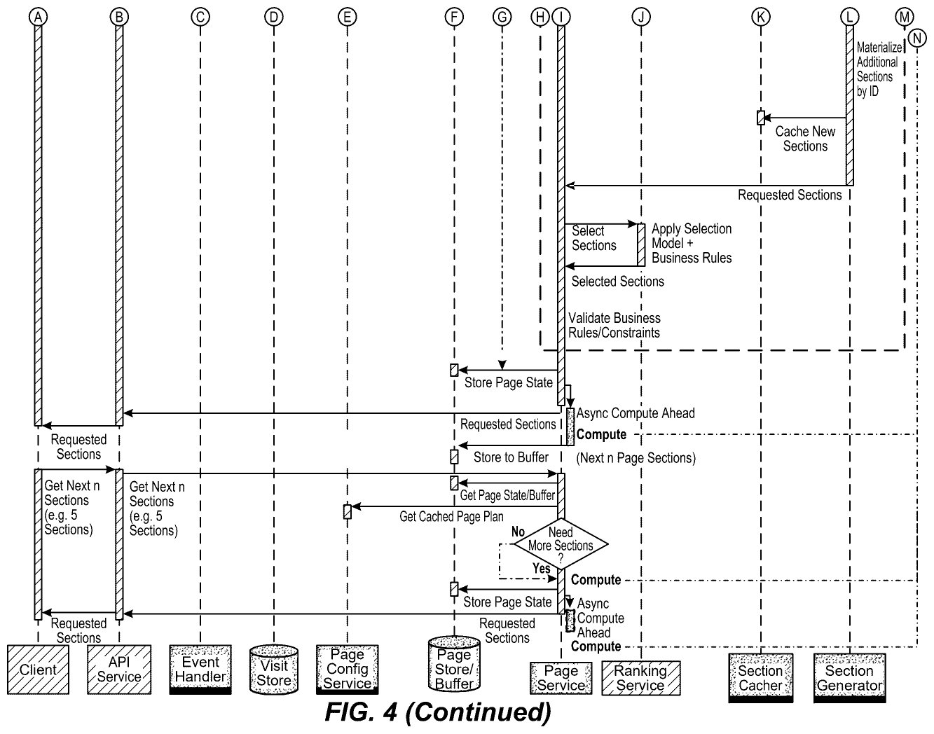

FIG. 4 illustrates an embodiment of a sequence diagram 400 in which precomputed user interface sections of an interactive user interface may be dynamically updated. This sequence diagram 400 illustrates page construction stages, including precomputation (before initial page request) based on an application boot (e.g., “AppBoot” or similar “session start” signal), an initial page fetch (paginated), and subsequent page fetches (also paginated).

The application programming interface (API) service 402 may provide UI pages to clients 401 via a paginated API that is exposed by the API service. The API service 402 may be configured to transform incoming queries from the client 401 to incoming requests at the event handler 403. The API service 402 may also be configured to transform the responses back into the paginated API schema expected by client devices (e.g., 401). The API service 402 may further be responsible for entity hydration (e.g., providing images, metadata, etc., which may be stored in visit store 404). Additionally or alternatively, the page service 407 may be configured to handle hydration responsibilities, including providing information to fill in the UI section (e.g., section title, section entities, description information for the entities, etc.). At least in some cases, the page service 407 may perform the UI section hydration using the page configuration service 405, which accesses stored page buffer data and page state information.

Furthermore, in FIG. 4, the section generator 410 may be configured to generate UI sections that are part of a UI page. At least in some cases, the section generator 410 may provide modular, reusable UI sections that can be added dynamically to (or dynamically removed from) a UI page. The section generator 410 may also be configured to manage section candidate selection (i.e., determining the subset of some or all possible UI sections to generate in a given context). At least in some cases, this functionality may be performed by the page service 407. The ranking service 408 may be configured to train and/or implement machine learning models to access potential entities and rank those entities for display in the client device.

Thus, in one embodiment, following one path through the sequence diagram, a client 401 may provide a boot or “session start” signal indicating that the media streaming application has been initialized. The event handler 403 may access past visit parameters and/or profile information for the user(s) tied to the client device 401. The page service 407 may compute the first N sections of the UI that will be provided to the user and may store the precomputed result in a page buffer 406 of the page configuration service 405. These initial UI sections may then be provided to the client device 401. The API service 402 may also receive these initial UI sections. The visit device store 404 may then be updated to indicate the user's visit to the media streaming service. The page configuration service 405 may generate a UI page plan and access precompute matching request parameters, if such are stored in the page buffer 406 of the page service 407.

If additional UI sections are needed, the page service 407 may begin the precompute process for the new UI sections. The section generator 410 may expand section specifications to section candidates. The ranking service 408 may prune the UI section candidates using a pruning model (e.g., an ML pruning model). The pruned section candidates are then returned to the section generator 410. The section generator 410 accesses any cached sections from the section cache 409, creates groups if needed, and provides the selected UI sections to the page service 407. The page service 407 then provides the selected UI sections to the API service 402 and/or to the client 401. The process then begins again if new sections are needed. The flow sequence of FIG. 4, it will be recognized, is merely one example of how the various modules and services of FIG. 3 may be implemented to precompute and dynamically apply new UI sections to a media streaming application's user interface.

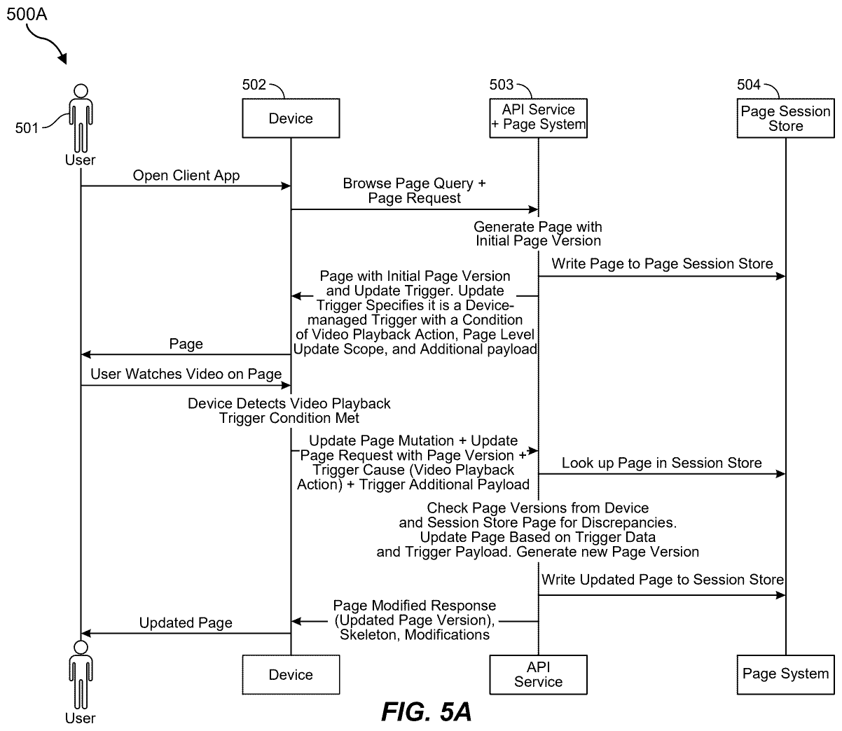

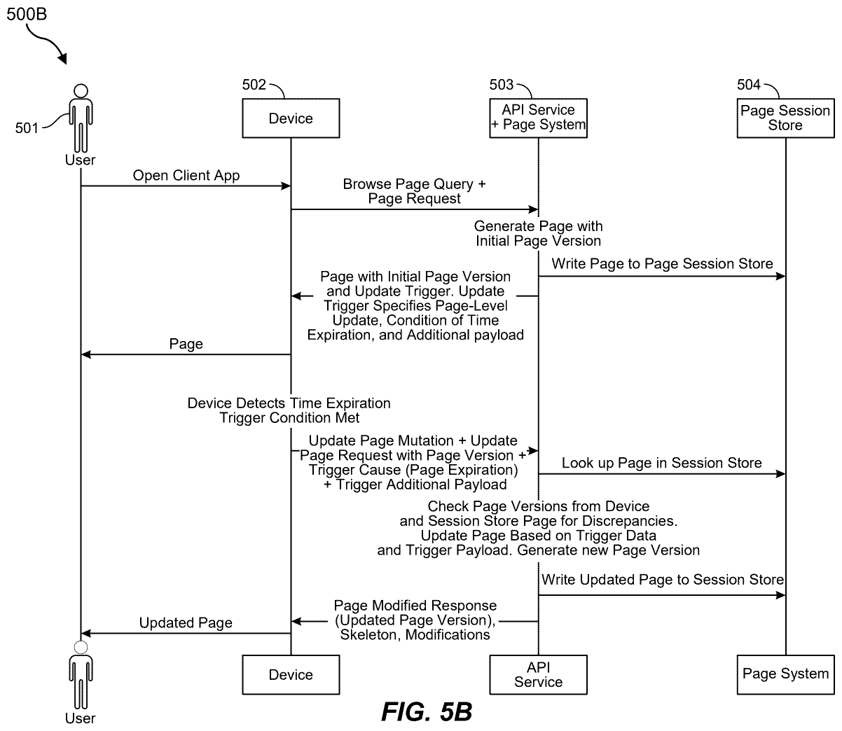

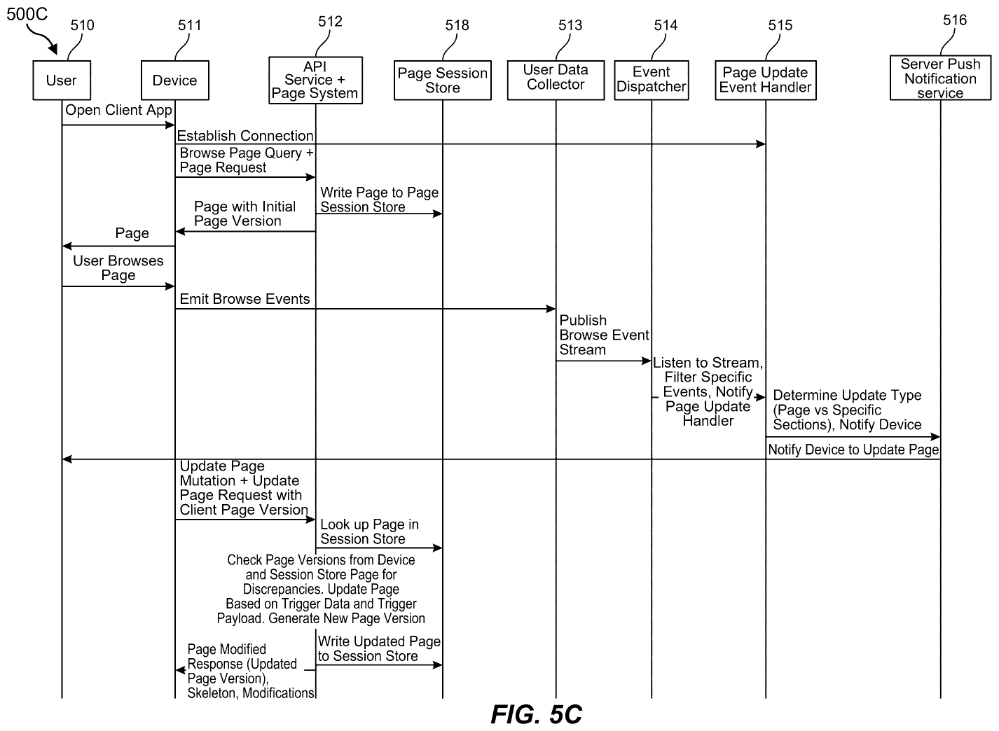

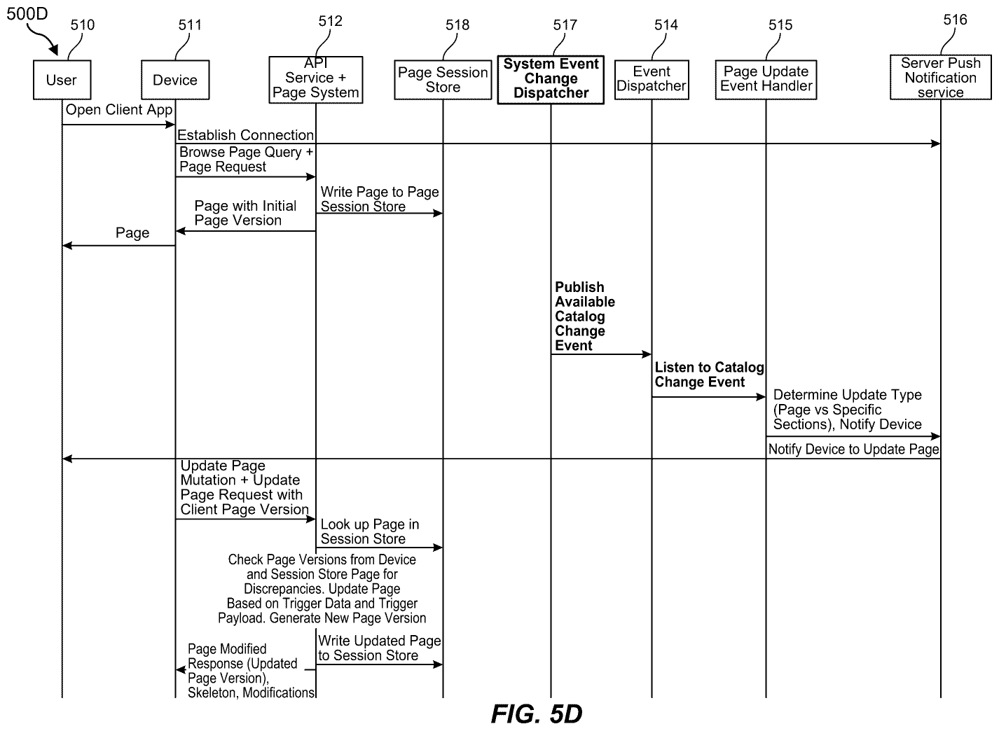

FIG. 5A illustrates a flow diagram 500A in which a user 501 opens a media streaming client application on their electronic device 502 (e.g., a smartphone or smart tv), watches a title, and receives updated UI section information after watching the title. This flow diagram may implement event listeners and associated actions. An event listener is a component that is present at both the UI page and UI section levels in the UI page response. The event listener provides guidance to clients on the specified actions that are to be taken for particular events (i.e., when a particular event occurs when specific user interactions occur on the client side).

The API service+page system 503 generates a page with an initial page version and writes the page to the page session store 504. The API service +page system 503 then sends the page with the initial page version and update trigger to the client device 502. Upon receiving the UI page from the API service+page system 503, the client may extract UI page and section-level event listeners and register them. The registration may identify which action is executed when a specific event occurs, as detected by the event listener. The event listeners instruct the client to monitor the page's expiration event. When this event is triggered, the client will execute the associated action. One example action may entail discarding the current UI page and retrieving a new UI page or UI section.

Another example action may include exiting a given title after watching some or all of that title. Upon triggering this action, the client is instructed by the event listener to initiate a page update action. This action may involve the client device 502 calling an “UpdatePage” mutation and passing the corresponding identifier for the action. Event listeners may function across different UI section types. Thus, any type of event listener may be incorporated into any UI section. The action identifier field within each UI section encodes any information that the server needs for performing page updates. The API service+page system 503 looks up the page in the session store 504, checks page version from the device and session store page for discrepancies, updates the page based on trigger data and trigger payload, and generates a new page version. The API service+page system 503 then writes the updated page to the session store 504 and sends the page modified response (with the updated page version), skeleton, and modifications to the client device 502, where the updated page is presented to the user 501.

Another type of event listener is a timeout. These timeout event listeners will have an expiration field that indicates when to trigger the associated action. For instance, an expiration field may be established for a “Top10” UI section on the page, alongside a separate expiration field for the entire UI page. Still further, an “exit player” event listener may detect when a user has stopped playing a title, thereby triggering the event listener upon exiting the media player. Thus, when a user watches a given title, a “Continue Watching” section may get updated to include that title. “Add to Playlist” or “Remove from Playlist” event listeners may be triggered when a user adds or removes a title from their playlist. Different updates may be applied to the UI page from the server for each of these operations.

Still further, a “click” event listener may trigger an action when a specific component receives a click event. In such cases, if the specific component receives a click, the UI page will be updated dynamically by the server. A “server notification” event may be triggered based on notifications received by the client. In some cases, the server may notify the client about events that ask the client to update its state after an initial page load. This notification process implements a server notification event listener. The server notification event listener is placed at either the page level or the section level. The server notification event listeners are responsible for listening to server notifications and triggering appropriate actions on the client side.

At least in some cases, notifications are delivered via different server push mechanisms, including third party notification delivery services, to their respective devices and websocket-based implementations. Each server notification event listener includes a message attribute (e.g., a regular expression), which is used to match specific messages or notifications from the delivery systems. When a message matches the regular expression (or other) pattern, a corresponding action is triggered (e.g., a page update). This notification mechanism allows the server to request clients to update the page through notifications, ensuring that web applications remain interactive and responsive to real-time data changes.

Other types of event listeners may also be used, including a “component mount” event listener, which is triggered when a component or node is mounted, and the event listener aids in keeping the page updated with any user interactions that occur when the page is not loaded (e.g., another page is being viewed), or the client application was in the background, etc.

At least in some cases, multiple action identifiers may be inputted into each request, allowing the client device 502 to potentially aggregate several events together. A single update request may contain an action identifier corresponding to exit player, add to playlist, and server notifications all at once. The server then examines these actions to determine which updates to dynamically apply to the UI page. The action identifiers in the update requests may originate from both UI page and section levels and, at least in some cases, the client does not need to pass information about the original location of the event listener within the page, as this information may already be encoded within the action identifiers.

If there are no modifications to be done on the UI page from the backend, a response indicating that the page was not modified may be returned to the client device 502. In such cases, clients do not have to change the UI page they are holding currently. If a modification is performed on the page, the server may cause the client device 502 to fetch a sparse page. The sparse page may include a page skeleton, with section identifiers (e.g., identifiers unique to each UI section) and UI page metadata.

For any section that is introduced to the page as part of the update, the section may be fetched in the same manner as a main page query. To fetch the page skeleton, the server may return a data field with page skeleton data. Simple page modifications assist clients in fetching section data only as required. For instance, a section refresh modification will point to the section edge that has been refreshed, enabling clients to fetch section data solely for that refreshed section. Having these two separate fields allows clients to fetch a sparse page in a single query.

At least in some cases, updates on a given UI page may not be confined to a single UI section or to merely updating the contents of UI sections. Depending on the user interactions or other events that have occurred, the server may opt to insert, delete, or move a section up or down on the UI page. This provides a dynamic and responsive interface that can adapt based on user behavior and other events.

These embodiments employ synchrony between the client and the server working on the same page. Once the initial page is fetched, there may be several subsequent ‘update page’ requests. At least in some cases, if a client misses any of those responses due to network issues, going offline, or other errors, the client can fall into an out-of-sync state. To prevent this from occurring, the embodiments herein may implement a page versioning system. The page version of a page is updated each time the UI page is modified. On the server side, the server tracks this version at the UI section level as well. As such, each UI section will have a page version value indicating when that section was last updated.

At least in some cases, the client may be configured to include the page version as part of each update request. The server may then respond with a page modified response, not only if a UI section was updated in that request, but also if the server finds any section that has been updated subsequent to the page version being sent by the client. This approach may aid the client in recovering and synchronizing with the version currently maintained by the server.

FIG. 5B is similar to FIG. 5A, but instead of a user-based trigger (e.g., video playback), a time-based trigger is implemented. After the user 501 opens the client application on the client device 502 and requests a page, the API service+page system 503 generates a page with an initial page version and writes the page to the session store 504. The API service+page system 503 then provides the page with an initial page version and update trigger to the client device. In this case, however, the update trigger specifies a page-level update and condition of time expiration. The page is presented to the user 501 and, after some time, the client device 502 detects a time expiration trigger condition. The client then creates an update page request with a page expiration indication, along with a trigger cause and payload trigger. Thereafter, the flow is the same as in FIG. 5A.

FIG. 5C illustrates an embodiment of server-driven page updates based on user activity (e.g. user browsing behavior, profile updates, membership plan changes, etc.). In the method flow 500B of FIG. 5C, a user 510 may open a client application on a client device 511. The client device then establishes a connection with a server push notification service 516 that is configured to send push notifications to clients. The client device also sends a page request to the API service and page system 512. The API service and page system 512 then writes the page to the page session store 517 and returns a page with an initial page version, which is presented to the user 510.

The user browses the page on the client device 511, and the client device emits one or more browse events to the user data collector 513. The user data collector 513 publishes a browse event stream to the event dispatcher 514, and the event dispatcher performs a variety of different tasks. For instance, in some cases, the event dispatcher 514 listens to the browse event stream, filters specific events from the event stream, and/or notifies the page update event handler 515. The page update event handler 515 determines the update type (e.g., page or specific sections of a page) and indicates the type to the server push notification service 516. The server push notification service 516 notifies the client device to update the specified page. The client device 511 then provides the update page mutation and update page request (that has the client page version) to the API service and page system 512. The API service and page system 512 then looks up the page in the session store 517, checks page versions from the client device and session store page for discrepancies. The API service and page system 512 further updates the page based on trigger data and trigger payload, generates a new page version, and writes the updated page to the session store 571. The API service and page system 512 then provides a page modified response with updated page version, as well as skeleton components and/or modifications for the page. In this manner, user activity may drive server-driven page updates.

FIG. 5D illustrates an embodiment of server-driven page updates based on system changes. This method flow 500C involves many of the steps described above in conjunction with FIG. 5C. The steps that differ are highlighted with hash marks. The differing steps are performed by a system event change dispatcher 517 and the event dispatcher 514. After the user 510 has opened their client application on their client device 511 and has received an initial page from the API service and page system 512, the system event change dispatcher 517 will publish an available catalog change event to the event dispatcher 514. The event dispatcher 514 will then listen to the catalog change event to note the pertinent system changes. The page update event handler 515 will then determine the update type and notify the server push notification service 516. The method flow will then continue as in FIG. 5C. In this example, it can be seen that system changes may initiate server-driven page updates in addition to or as an alternative to user activity.

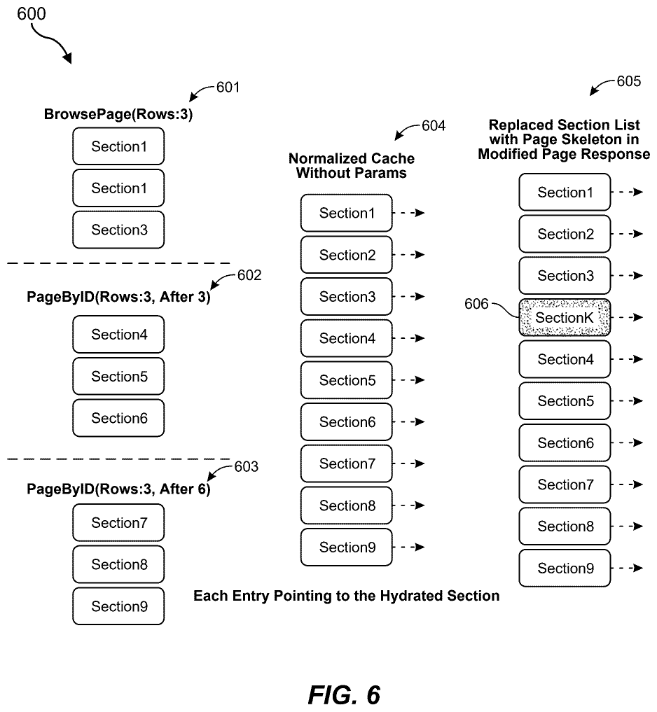

FIG. 6 illustrates an embodiment 600 in which UI sections are dynamically updated. In FIG. 6, the client may initially obtain the first chunk of the UI page via a “BrowsePage” query 601 and may obtain subsequent chunks through pagination queries (e.g., 602 & 603). The client services utilize the query as the cache key. As such, the same pagination scheme may be repeated when the user scrolls up, or a cache miss may occur. As discussed above with regard to FIG. 5, the “UpdatePage” mutation may return a modified page response that includes the full UI page generated so far. The agreement between the client and server entails that clients will fetch the skeleton page to replace the continuous list of sections 605.

In one example, during the update, a new section 606 with a section identifier “SectionK” is inserted at position 4, and the contents of Section3 are updated. Once the client fetches the skeleton page and replaces the section list on the client side, the inserted section identifier will be in the correct position. The page modifications will contain the hydrated SectionK fields, so the SectionK identifier in the cache will be pointed to the correct hydrated metadata entry. In the case of an existing section like Section 3 that was updated, the section identifier may remain the same during the update. As such, the pointer to the cache entry remains the same, but the hydrated section data will be fetched from the page modifications cache and be replaced. In some cases, the server asks client devices to perform cache normalization (e.g., at 604), where individual chunks of sections are joined together to form a continuous list of sections. When there is a lookup for, say, the first three sections, the corresponding section is then extracted and returned.

The computing modules and diagrams of FIGS. 3-6 may be implemented in conjunction with or in addition to the modules of computer system 101 of FIG. 1. As noted above, the computer system 101 may be implemented to dynamically update precomputed user interface sections (e.g., 119 and 121) of an interactive user interface 118. As part of this process, the event listener instantiating module 109 may instantiate various event listeners 110 that are associated with different events 123. If those events occur, the adaptive UI generating module 113 may create, using one or more of the compute strategies described above, at least one updated UI section 114.

In some embodiments, each of the event listeners 110 may be specifically assigned to listen for events 123 from different precomputed sections of the UI. Thus, for instance, UI section A (119) may have its own event listener A (120), UI section B (121) may have its own event listener (122), and so on. The event listener 120 may listen for events related to or that are associated with the content or structure of UI section A (119), while the event listener B (122) may listen for events related to or associated with UI section B (121). Events from non-corresponding event listeners may be ignored or forwarded to the appropriate event listener.

In some embodiments, at least two of the event listeners for a given UI page or UI section may be different types of event listeners. For instance, as described above, the event listeners may listen for request timeouts, exit media player events, mouse clicks or touchscreen taps, server notifications, component initializations, or other events. In some cases, a single UI section may have many different event listeners, while in other cases, a UI section may have only one event listener.

In one embodiment, a user 116 may provide input 117 on their mobile device and that input may be transmitted to the computer system 101. The receiver 105 may receive the input 117 from the user's interaction with the user interface presented on the mobile device. The event listener 110 may determine that the input 117 received from the client device includes or triggers an event associated with a specific UI section (e.g., 119). The dynamic UI updating module 115 may then update the specified UI sections to include a newly updated version (e.g., 114) of the specified UI section. The newly updated version may be adaptively computed on-the-fly and may be precomputed, even if portions of the UI section have already been processed. Each UI section may have its own unique identifier and version number. As such, the computer system may track which version of the UI section is being implemented for a given UI page. When an updated UI section 126 is dynamically placed into the UI page, the version number for that updated UI section may be tracked and used to determine, after subsequent events have occurred, whether the most up-to-date version of the UI section is being used.

In another embodiment, a user 116 may provide an input 117 selecting at least one media item from the user interface 118. In some cases, this input may be an event 111 that is listened for by an event listener 110. The user's selection may affect some sections of the UI (e.g., the “Continue Watching” UI section may now have a new entry for the user's media item selection). The precomputed “Continue Watching” UI section may be updated based on the user's selection. Moreover, if the user makes further selections or scrolls to different parts of the media streaming UI, the UI 118 may be dynamically updated as further events are triggered for different precomputed sections of the UI. The events 111 associated with the various event listeners (e.g., 120 or 122) may include explicit signals from the client device (e.g., touchscreen inputs or mouse clicks), implicit signals from the client device (the user has repeatedly avoided selecting a specific media item), or a system-wide event (e.g., a live title launch that comes online at a specified time and is available to all users of the media streaming platform (or all users within a given geographic region)).

As noted previously, the systems herein may be configured to interrupt the processing that may be currently underway in order to accommodate new events. For example, in some cases, the underlying system may determine that a specified user interface section (e.g., 119) is being recomputed based on the occurrence of an event 123 associated with the event listener 120. The system may then signal that any new incoming events may cancel the in-flight processing currently underway and may begin adaptively computing the updated UI section based on the new event. Additionally or alternatively, the system may signal that further updates to the specified user interface section are to be preempted until a specified instance of the recompute has completed. This may ensure that an updated UI section is available for presentation on the UI, while also ensuring that new UI sections are generated based on the occurrence of new events.

At least in some embodiments, machine learning models may be implemented to track and learn from user behavior. In some cases, ML models may be trained to determine, based on past inputs received from the user 116 (and potentially inputs received from similar users), which inputs or selections the user is likely to make in the future. The system may then precompute one or more UI sections based on inputs that are likely to be received at the client device. The precomputed user interface sections may be stored in and served from a page buffer (e.g., page buffer 312 of FIG. 3).

Additionally or alternatively, the machine learning models may be trained to determine which user interface sections are to be presented on the client device, which entities to place in each user interface section, and/or which order to place the entities in within the user interface based on contextual information associated with the client device or based on user preferences. The ML models may look at the user's past selections and other users'past selections to predict which entities (e.g., videos, television shows, video games, etc.) the user would be likely to select and consume. Moreover, the ML models may determine which UI sections would be the best fit in which to present the entities. Still further, the ML models may order the entities based on which are most likely to be selected and show those entities in specific locations within the UI section(s). As such, the ML models may be trained to optimize presentation of the entities by learning from prior selections and prior UI presentations to the user and other users.

Once the computer system (e.g., a server computer system) has determined which entities to present and where they are to be presented in the UI, the precomputed UI sections may be served from a page buffer, along with at least a portion of aggregated, served page state. The aggregated, served page state may indicate which UI data has previously been served and presented in the client application. The precomputed UI sections may supplement or replace the aggregated, served page state. In some cases, the precomputed user interface sections may be additionally served with page information that was computed offline, prior to initiation of the current client session.

In some embodiments, precomputed results may be used even when the results become available after a new page (or new UI section) request starts. At least in some cases, the server computer system may start an event listener thread that is notified when in-flight precompute results (e.g., UI sections) become available. The server may then abandon the in-request, live compute and may instead use the precomputed results. (In-flight results are based on what the user is currently looking at—if the user just watched a preview for a documentary, for example, the server will recommend more documentaries, will precompute those results, and then update the UI page with those results). This server-driven UI approach, which serves dynamically modified UI pages in real time based on live signals, may greatly reduce processing latency and staleness in the UI and may increase the UI's responsiveness when responding to user interactions.

In addition to the above-described method, a system may be provided that includes at least one physical processor and physical memory comprising computer-executable instructions that, when executed by the physical processor, cause the physical processor to: precompute one or more sections of a user interface (UI) that is to be displayed on a client device, instantiate one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred, upon determining that the event associated with the event listener has occurred, adaptively generate an updated version of the corresponding section of the UI that is associated with the identified event listener, and dynamically update the user interface to include the adaptively generated, updated version of the corresponding user interface section.

Still further, in addition to the above-described method, a non-transitory computer-readable medium may be provided that includes one or more computer-executable instructions that, when executed by at least one processor of a computing device, cause the computing device to: precompute one or more sections of a user interface (UI) that is to be displayed on a client device, instantiate one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred, upon determining that the event associated with the event listener has occurred, adaptively generate an updated version of the corresponding section of the UI that is associated with the identified event listener, and dynamically update the user interface to include the adaptively generated, updated version of the corresponding user interface section.

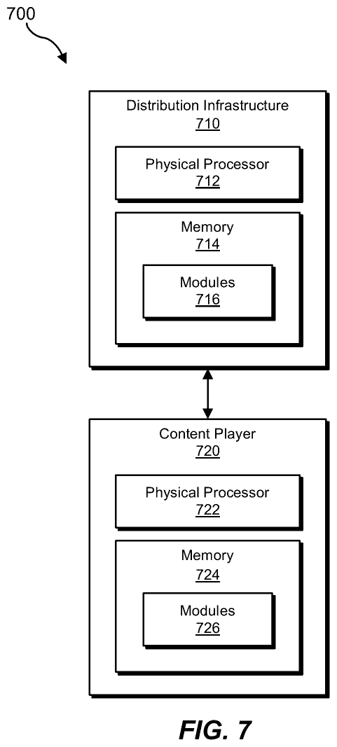

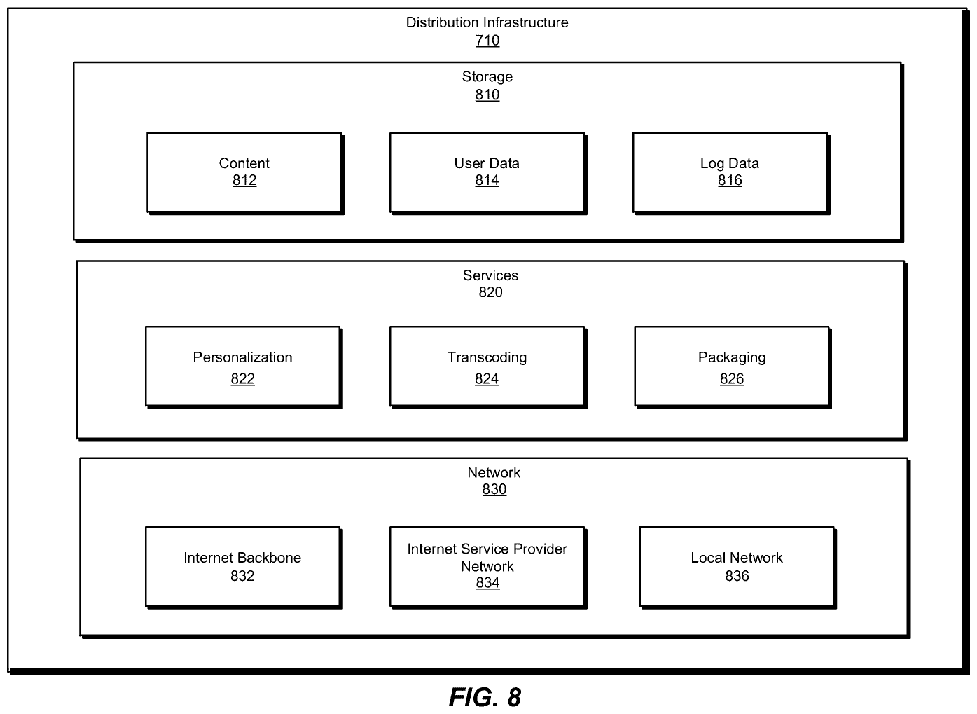

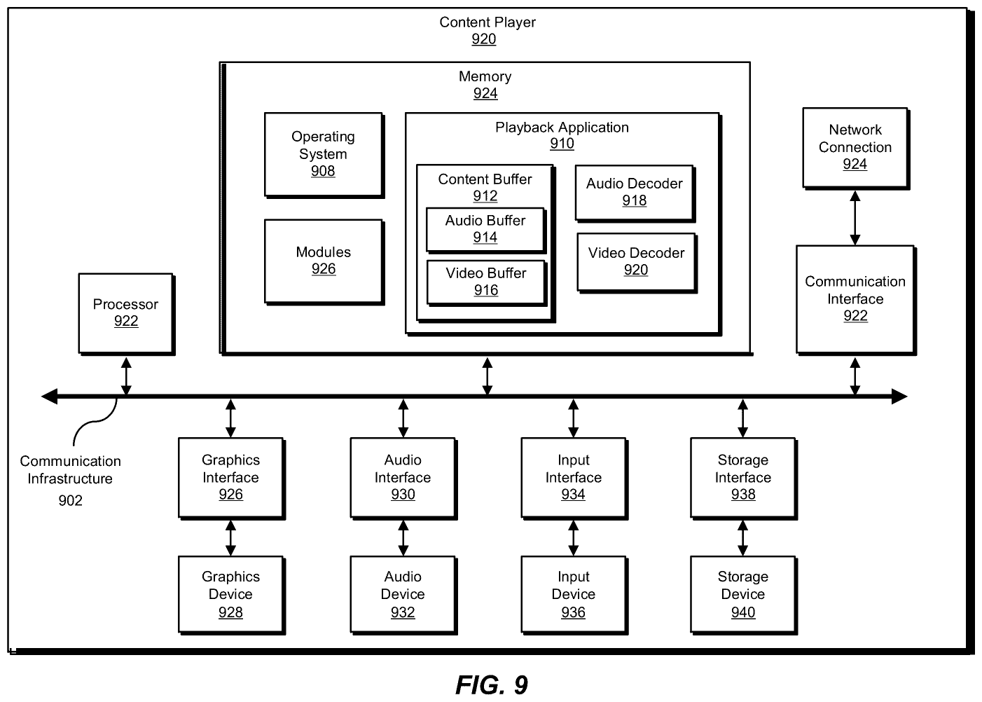

The following will provide, with reference to FIG. 7, detailed descriptions of exemplary ecosystems in which content is provisioned to end nodes and in which requests for content are steered to specific end nodes. The discussion corresponding to FIGS. 8 and 9 presents an overview of an exemplary distribution infrastructure and an exemplary content player used during playback sessions, respectively. These exemplary ecosystems and distribution infrastructures are implemented in any of the embodiments described above with reference to FIGS. 1-9.

FIG. 7 is a block diagram of a content distribution ecosystem 700 that includes a distribution infrastructure 710 in communication with a content player 720. In some embodiments, distribution infrastructure 710 is configured to encode data at a specific data rate and to transfer the encoded data to content player 720. Content player 720 is configured to receive the encoded data via distribution infrastructure 710 and to decode the data for playback to a user. The data provided by distribution infrastructure 710 includes, for example, audio, video, text, images, animations, interactive content, haptic data, virtual or augmented reality data, location data, gaming data, or any other type of data that is provided via streaming.

Distribution infrastructure 710 generally represents any services, hardware, software, or other infrastructure components configured to deliver content to end users. For example, distribution infrastructure 710 includes content aggregation systems, media transcoding and packaging services, network components, and/or a variety of other types of hardware and software. In some cases, distribution infrastructure 710 is implemented as a highly complex distribution system, a single media server or device, or anything in between. In some examples, regardless of size or complexity, distribution infrastructure 710 includes at least one physical processor 712 and at least one memory device 714. One or more modules 716 are stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 includes a physical processor 722, memory 724, and one or more modules 726. Some or all of the adaptive streaming processes described herein is performed or enabled by modules 726, and in some examples, modules 716 of distribution infrastructure 710 coordinate with modules 726 of content player 720 to provide adaptive streaming of digital content.

In certain embodiments, one or more of modules 716 and/or 726 in FIG. 7 represent one or more software applications or programs that, when executed by a computing device, cause the computing device to perform one or more tasks. For example, and as will be described in greater detail below, one or more of modules 716 and 726 represent modules stored and configured to run on one or more general-purpose computing devices. One or more of modules 716 and 726 in FIG. 7 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 712 and 722 generally represent any type or form of hardware-implemented processing unit capable of interpreting and/or executing computer-readable instructions. In one example, physical processors 712 and 722 access and/or modify one or more of modules 716 and 726, respectively. Additionally or alternatively, physical processors 712 and 722 execute one or more of modules 716 and 726 to facilitate adaptive streaming of digital content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 stores, loads, and/or maintains one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of content distribution infrastructure 710 according to certain embodiments. Distribution infrastructure 710 includes storage 810, services 820, and a network 830. Storage 810 generally represents any device, set of devices, and/or systems capable of storing content for delivery to end users. Storage 810 includes a central repository with devices capable of storing terabytes or petabytes of data and/or includes distributed storage systems (e.g., appliances that mirror or cache content at Internet interconnect locations to provide faster access to the mirrored content within certain regions). Storage 810 is also configured in any other suitable manner.

As shown, storage 810 may store a variety of different items including content 812, user data 814, and/or log data 816. Content 812 includes television shows, movies, video games, user-generated content, and/or any other suitable type or form of content. User data 814 includes personally identifiable information (PII), payment information, preference settings, language and accessibility settings, and/or any other information associated with a particular user or content player. Log data 816 includes viewing history information, network throughput information, and/or any other metrics associated with a user's connection to or interactions with distribution infrastructure 710.

Services 820 includes personalization services 822, transcoding services 824, and/or packaging services 826. Personalization services 822 personalize recommendations, content streams, and/or other aspects of a user's experience with distribution infrastructure 710. Encoding services 824 compress media at different bitrates which, as described in greater detail below, enable real-time switching between different encodings. Packaging services 826 package encoded video before deploying it to a delivery network, such as network 830, for streaming.

Network 830 generally represents any medium or architecture capable of facilitating communication or data transfer. Network 830 facilitates communication or data transfer using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 includes an Internet backbone 832, an internet service provider 834, and/or a local network 836. As discussed in greater detail below, bandwidth limitations and bottlenecks within one or more of these network segments triggers video and/or audio bit rate adjustments.

FIG. 9 is a block diagram of an exemplary implementation of content player 720 of FIG. 7. Content player 720 generally represents any type or form of computing device capable of reading computer-executable instructions. Content player 720 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 includes a communication infrastructure 902 and a communication interface 922 coupled to a network connection 924. Content player 720 also includes a graphics interface 926 coupled to a graphics device 928, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 stores and/or loads an operating system 908 for execution by processor 722. In one example, operating system 908 includes and/or represents software that manages computer hardware and software resources and/or provides common services to computer programs and/or applications on content player 720.

Operating system 908 performs various system management functions, such as managing hardware components (e.g., graphics interface 926, audio interface 930, input interface 934, and/or storage interface 938). Operating system 908 also provides process and memory management models for playback application 910. The modules of playback application 910 includes, for example, a content buffer 912, an audio decoder 918, and a video decoder 920.

Playback application 910 is configured to retrieve digital content via communication interface 922 and play the digital content through graphics interface 926. Graphics interface 926 is configured to transmit a rendered video signal to graphics device 928. In normal operation, playback application 910 receives a request from a user to play a specific title or specific content. Playback application 910 then identifies one or more encoded video and audio streams associated with the requested title. After playback application 910 has located the encoded streams associated with the requested title, playback application 910 downloads sequence header indices associated with each encoded stream associated with the requested title from distribution infrastructure 710. A sequence header index associated with encoded content includes information related to the encoded sequence of data included in the encoded content.

In one embodiment, playback application 910 begins downloading the content associated with the requested title by downloading sequence data encoded to the lowest audio and/or video playback bitrates to minimize startup time for playback. The requested digital content file is then downloaded into content buffer 912, which is configured to serve as a first-in, first-out queue. In one embodiment, each unit of downloaded data includes a unit of video data or a unit of audio data. As units of video data associated with the requested digital content file are downloaded to the content player 720, the units of video data are pushed into the content buffer 912. Similarly, as units of audio data associated with the requested digital content file are downloaded to the content player 720, the units of audio data are pushed into the content buffer 912. In one embodiment, the units of video data are stored in video buffer 916 within content buffer 912 and the units of audio data are stored in audio buffer 914 of content buffer 912.

A video decoder 920 reads units of video data from video buffer 916 and outputs the units of video data in a sequence of video frames corresponding in duration to the fixed span of playback time. Reading a unit of video data from video buffer 916 effectively de-queues the unit of video data from video buffer 916. The sequence of video frames is then rendered by graphics interface 926 and transmitted to graphics device 928 to be displayed to a user.

An audio decoder 918 reads units of audio data from audio buffer 914 and outputs the units of audio data as a sequence of audio samples, generally synchronized in time with a sequence of decoded video frames. In one embodiment, the sequence of audio samples is transmitted to audio interface 930, which converts the sequence of audio samples into an electrical audio signal. The electrical audio signal is then transmitted to a speaker of audio device 932, which, in response, generates an acoustic output.

In situations where the bandwidth of distribution infrastructure 710 is limited and/or variable, playback application 910 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 926 is configured to generate frames of video data and transmit the frames of video data to graphics device 928. In one embodiment, graphics interface 926 is included as part of an integrated circuit, along with processor 722. Alternatively, graphics interface 926 is configured as a hardware accelerator that is distinct from (i.e., is not integrated within) a chipset that includes processor 722.

Graphics interface 926 generally represents any type or form of device configured to forward images for display on graphics device 928. For example, graphics device 928 is fabricated using liquid crystal display (LCD) technology, cathode-ray technology, and light-emitting diode (LED) display technology (either organic or inorganic). In some embodiments, graphics device 928 also includes a virtual reality display and/or an augmented reality display. Graphics device 928 includes any technically feasible means for generating an image for display. In other words, graphics device 928 generally represents any type or form of device capable of visually displaying information forwarded by graphics interface 926.

As illustrated in FIG. 9, content player 720 also includes at least one input device 936 coupled to communication infrastructure 902 via input interface 934. Input device 936 generally represents any type or form of computing device capable of providing input, either computer or human generated, to content player 720. Examples of input device 936 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 720 also includes a storage device 940 coupled to communication infrastructure 902 via a storage interface 938. Storage device 940 generally represents any type or form of storage device or medium capable of storing data and/or other computer-readable instructions. For example, storage device 940 is a magnetic disk drive, a solid-state drive, an optical disk drive, a flash drive, or the like. Storage interface 938 generally represents any type or form of interface or device for transferring data between storage device 940 and other components of content player 720.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

### EXAMPLE EMBODIMENTS

### Example 1

A computer-implemented method comprising: precomputing one or more sections of a user interface (UI) that is to be displayed on a client device, instantiating one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred, upon determining that the event associated with the event listener has occurred, adaptively generating an updated version of the corresponding section of the UI that is associated with the identified event listener, and dynamically updating the user interface to include the adaptively generated, updated version of the corresponding user interface section.

### Example 2

The computer-implemented method of Example 1, wherein each of the one or more event listeners is specifically assigned to listen for events from a different precomputed section of the UI.

### Example 3

The computer-implemented method of Example 1 or Example 2, wherein at least two event listeners comprise different types of event listeners.

### Example 4

The computer-implemented method of any of Examples 1-3, further comprising receiving an input from the client device interacting with the user interface, determining that the input received from the client device comprises an event associated with a specified UI section, and dynamically updating the specified UI section to include a newly updated version of the specified UI section.

### Example 5

The computer-implemented method of any of Examples 1-4, wherein the input received from the client device comprises input selecting at least one media item from the user interface.

### Example 6

The computer-implemented method of any of Examples 1-5, wherein the UI is dynamically updated as further events are triggered for different precomputed sections of the UI.

### Example 7

The computer-implemented method of any of Examples 1-6, wherein the event associated with the event listener comprises at least one of: an explicit signal from the client device, an implicit signal from the client device, or a system-wide event.

### Example 8

The computer-implemented method of any of Examples 1-7, further comprising determining that a specified user interface section is being recomputed based on the occurrence of the event associated with the event listener and signaling that further updates to the specified user interface section are to be preempted until completion of the recompute.

### Example 9

The computer-implemented method of any of Examples 1-8, wherein a plurality of user interface sections are precomputed based on likely inputs received at the client device.

### Example 10

The computer-implemented method of any of Examples 1-9, wherein the precomputed user interface sections are stored in and served from a page buffer.

### Example 11

The computer-implemented method of any of Examples 1-10, wherein the precomputed user interface sections are served from the page buffer along with at least a portion of aggregated, served page state.

### Example 12

The computer-implemented method of any of Examples 1-11, wherein the precomputed user interface sections are additionally served with page information that was computed offline, prior to initiation of a current client session.

### Example 13

A system comprising at least one physical processor and physical memory comprising computer-executable instructions that, when executed by the physical processor, cause the physical processor to: precompute one or more sections of a user interface (UI) that is to be displayed on a client device, instantiate one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred, upon determining that the event associated with the event listener has occurred, adaptively generate an updated version of the corresponding section of the UI that is associated with the identified event listener, and dynamically update the user interface to include the adaptively generated, updated version of the corresponding user interface section.

### Example 14

The system of Example 13, wherein the physical processor is further configured to train one or more machine learning (ML) models to determine which user interface sections are to be presented on the client device.

### Example 15

The system of Example 14, wherein the ML models further determine which entities to place in each user interface section.

### Example 16

The system of Example 14 or Example 15, wherein the ML models further determine in which order to place the entities within the user interface based on contextual information associated with the client device or based on user preferences.

### Example 17

The system of any of Examples 14-16, wherein the physical processor is further configured to receive an input from the client device interacting with the user interface, determine that the input received from the client device comprises an event associated with a specified UI section, and dynamically update the specified UI section to include a newly updated version of the specified UI section.

### Example 18

The system of Examples 14-17, wherein the input received from the client device comprises input selecting at least one media item from the user interface.

### Example 19

The system of any of Examples 14-18, wherein the UI is dynamically updated as further events are triggered for different precomputed sections of the UI.

### Example 20

A non-transitory computer-readable medium comprising one or more computer-executable instructions that, when executed by at least one processor of a computing device, cause the computing device to: precompute one or more sections of a user interface (UI) that is to be displayed on a client device, instantiate one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred, upon determining that the event associated with the event listener has occurred, adaptively generate an updated version of the corresponding section of the UI that is associated with the identified event listener, and dynamically update the user interface to include the adaptively generated, updated version of the corresponding user interface section.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
precomputing one or more sections of a user interface (UI) that is to be displayed on a client device;
instantiating one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred;
upon determining that the event associated with the event listener has occurred, adaptively generating an updated version of the corresponding section of the UI that is associated with the event listener; and
dynamically updating the user interface to include the adaptively generated, updated version of the corresponding user interface section.

2. The computer-implemented method of claim 1, wherein each of the one or more event listeners is specifically assigned to listen for events from a different precomputed section of the UI.

3. The computer-implemented method of claim 2, wherein at least two event listeners comprise different types of event listeners.

4. The computer-implemented method of claim 1, further comprising:
receiving an input from the client device interacting with the user interface;
determining that the input received from the client device comprises an event associated with a specified UI section; and
dynamically updating the specified UI section to include a newly updated version of the specified UI section.

5. The computer-implemented method of claim 4, wherein the input received from the client device comprises input selecting at least one media item from the user interface.

6. The computer-implemented method of claim 4, wherein the UI is dynamically updated as further events are triggered for different precomputed sections of the UI.

7. The computer-implemented method of claim 1, wherein the event associated with the event listener comprises at least one of: an explicit signal from the client device, an implicit signal from the client device, or a system-wide event.

8. The computer-implemented method of claim 1, further comprising:
determining that a specified user interface section is being recomputed based on the occurrence of the event associated with the event listener; and
signaling that further updates to the specified user interface section are to be preempted until completion of the recompute.

9. The computer-implemented method of claim 1, wherein a plurality of user interface sections are precomputed based on likely inputs received at the client device.

10. The computer-implemented method of claim 1, wherein the precomputed user interface sections are stored in and served from a page buffer.

11. The computer-implemented method of claim 10, wherein the precomputed user interface sections are served from the page buffer along with at least a portion of aggregated, served page state.

12. The computer-implemented method of claim 11, wherein the precomputed user interface sections are additionally served with page information that was computed offline, prior to initiation of a current client session.

13. A system comprising:
at least one physical processor;
an electronic display; and
physical memory comprising computer-executable instructions that, when executed by the physical processor, cause the physical processor to:
precompute one or more sections of a user interface (UI) that is to be displayed on a client device;
instantiate one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred;
upon determining that the event associated with the event listener has occurred, adaptively generate an updated version of the corresponding section of the UI that is associated with the event listener; and
dynamically update the user interface to include the adaptively generated, updated version of the corresponding user interface section.

14. The system of claim 13, wherein the physical processor is further configured to train one or more machine learning (ML) models to determine which user interface sections are to be presented on the client device.

15. The system of claim 14, wherein the ML models further determine which entities to place in each user interface section.

16. The system of claim 15, wherein the ML models further determine in which order to place the entities within the user interface based on contextual information associated with the client device or based on user preferences.

17. The system of claim 14, wherein the physical processor is further configured to:
receive an input from the client device interacting with the user interface;
determine that the input received from the client device comprises an event associated with a specified UI section; and
dynamically update the specified UI section to include a newly updated version of the specified UI section.

18. The system of claim 17, wherein the input received from the client device comprises input selecting at least one media item from the user interface.

19. The system of claim 17, wherein the UI is dynamically updated as further events are triggered for different precomputed sections of the UI.

20. A non-transitory computer-readable medium comprising one or more computer-executable instructions that, when executed by at least one processor of a computing device, cause the computing device to:
precompute one or more sections of a user interface (UI) that is to be displayed on a client device;
instantiate one or more event listeners associated with one or more corresponding precomputed sections of the UI that are subject to change based on the occurrence of an associated event, wherein the event listeners are configured to provide, for one or more changeable sections of the UI, an indication of whether the event associated with the event listener has occurred;
upon determining that the event associated with the event listener has occurred, adaptively generate an updated version of the corresponding section of the UI that is associated with the event listener; and
dynamically updating the user interface to include the adaptively generated, updated version of the corresponding user interface section.
